(19) United States
(12) Patent Application Publication
(10) Pub. No.: US 2023/0035975 A1
(43) Pub. Date: Feb. 2, 2023

(54) HYDRAULIC APPARATUS, AND METHOD, FOR THE RECOVERY OF ENERGY IN A OPERATING MACHINE

(71) Applicants: CARLO MARIA ROZZI DE HIERONYMIS, MARZABOTTO (IT); GIORGIO BORDINI, SAN CESARIO SUL PANARO (IT)

(72) Inventors: CARLO MARIA ROZZI DE HIERONYMIS, MARZABOTTO (IT); GIORGIO BORDINI, SAN CESARIO SUL PANARO (IT)

(21) Appl. No.: 17/775,093

(22) PCT Filed: Oct. 28, 2020
(86) PCT No.: PCT/IT2020/000072

§ 371 Date: May 6, 2022

(30) Foreign Application Priority Data
Nov. 12, 2019 (IT) 102019000020685

(51) Int. Cl. F15B 1/08; F15B 1/24

(52) U.S. Cl. CPC F15B 1/08; F15B 1/24

(57) ABSTRACT

An hydraulic apparatus (100) for energy recovery in an operating machine comprising an hydro-pneumatic accumulator (14) able to accumulate, during the operation of lowering of an operative load (111) by an operating machine (1), a volume of oil with a fixed amount of an inert fluid, and the pre-charge pressure (Po) of which, before the beginning of the accumulation, is adjusted according to the variations of pressure of the oil inside the hydraulic cylinders (12,13) which act on the operative load (111), in such a way to accumulate the maximum hydraulic energy made available by the lowering of operating load (111), that is to maximize the average pressure of hydro-pneumatic accumulator (14) during the phase of accumulation of energy.

### 1. TECHNICAL FIELD OF THE INVENTION

The present invention is related to the field of the systems of hydraulic actuation.

Furthermore, this system is of the self-adaptive type.

It is obvious to the man skilled in the art that the teachings of the present invention are applicable also to pneumatic systems.

In the present description, the term “hydraulic” can be considered to all effects a synonymous of the term “oleodynamic”.

It is well known that systems of hydraulic (or pneumatic) actuation are commonly used also for lifting and lowering operating weights of considerable and variable entity.

The system described in the present invention is able to accumulate a relevant fraction of the energy recoverable from the lowering of operating weights, and then make it available for the system of actuation for the next lifting phase. Also at change of the operating weight, by means of the self-adaptation to the operative pressure values which change in the time according to the variation of the operating load itself.

The accumulation and the return of the energy takes place by means of the compression, and, respectively, of the expansion of a fixed amount of gas, within an accumulator, advantageously of oleo-pneumatic type, the operative pressure of which adapts itself to the current pressure of the oil of the hydraulic actuators which control the lowering and the lifting of the operating load. Thus, without changing the amount of gas present inside the oleo-pneumatic accumulator, but only its volume.

A typical applicative field of the present invention is the one of the hydraulic cranes for lifting, of the hydraulic excavators, and any other, hydraulically operated, machinery for lifting, where operational sequence may include frequent maneuvers of lifting and lowering of operating loads which can change from maneuver to maneuver, like, for instance, the boom of an excavator, which, as it is known, can vertically operate buckets of variable weight, or large demolition shears provided with hydraulic control.

Furthermore, other typical applications of this invention are systems of actuation which operate within energy fields of conservative type, like acceleration and deceleration of large masses of variable type, like in the case of the swing of the boom of an excavator.

### 2. STATE OF THE ART

Within the field of the systems of hydraulic actuation, in absence of devices of recovery of energy, it is well known that during the operation of lowering of an operating load, hydraulic valves of control allow the controlled discharge of an oil flow outgoing from the hydraulic actuators in charge of lifting and lowering.

Pressurized oil is operated by the forces due to the operating load, which, in the case of an excavator, is substantially made up of the weight of the boom and the weight of the lifted load.

Since the operating load may change from lifted load to lifted load, in the same machine, or from machine to machine, depending on the carried tool or on the lifted weight, also the pressure of the pressurized oil changes accordingly.

The control of the oil flow is a key factor for the control of the lifting operation, and, particularly, of the lowering operation, and generally during the lowering such operation of control takes place substantially through lamination of the oil, which is pushed by the lifting cylinders inside the lowering control valves.

Lamination reduces the pressure of the oil, before it returns into the oil tank of the machinery, from the value as set by the cylinders to the value of the oil tank, that is relative pressure equal to zero. Consequently, all the energy of the oil coming out from the cylinders is transformed into heat and then lost.

In other words, all the energy spent to lift an operating load is degraded into a heating of the oil, and therefore not only made unusable, but with consequent need of further energy to cool down the oil itself.

In other more developed systems it has been tried to recuperate at least one part of the energy.

Actually, in presence of devices of recuperation of energy one part of the theoretical energy connected to the lowering of the operating load, and equal to the variation of potential energy, can be partially stored by compression of an elastic mean in an accumulator, which accumulator can return, in whole or in part, the stored energy.

The elastic mean can be, for example, a mechanical spring associated to an hydraulic cylinder, or a gas accumulator, or any other device able to store energy.

The main drawback of energy recuperation systems currently in use consists in the fact that the amount of energy recoverable by the accumulator depends on the energy, outcoming from the hydraulic circuit, that can be received by the accumulator itself, in other words it depends on the fact that the pressure of the oil of the lifting cylinders can actually be enough higher than the pressure which is generated inside the accumulator during all the phase of recuperation of the energy itself.

Consequently, it has to be understood how, if the pressure inside the accumulator should grow above the pressure of the oil inside the cylinders during the lowering phase, accumulation is not possible any more, viceversa, if the pressure in the accumulator would stay far lower than the pressure inside the cylinders, during the lowering operation, the recuperated energy would result lower than the maximum of recoverable energy, since it is proportional, anyway, for a given volume of accumulated oil, to the accumulation pressure, which, as it has been said, is lower than the operating pressure inside the lifting cylinders.

Since the oil pressure inside the cylinders, during the lowering phase may change for different reasons, among which, the variable geometric configuration of the lowering device, but, above all, the value of the operating load (it is enough to think that the boom of an excavator can carry tools of very different weight, according to the operation itself), it is not possible, according to the prior art, optimize the pressure inside the accumulator, according to the pressure of the oil of the cylinders during the lowering.

Consequently, according to the state of the art, to avoid that the first of the two circumstances described may happen, which would take to the stop or anyway to the lack of control of the operation of lowering, it is preferred to reduce the range of the pressure inside the accumulator, with the consequent reduction of the recoverable energy.

Such limitation may jeopardize the convenience to use such energy recuperation system, unless of an ad hoc fine tuning, and from time to time, of the pressure of the accumulator at the very beginning of the lowering maneuver. However, such fine tuning would not result practically feasible, according to the technique of the known art, since it would require to change the preload of the spring, or, respectively, the amount of charge of gas, operation absolutely impractical during the work of any operating machine. In fact, said operation would require to have, together with the work equipment, a source of pressurized gas at a pressure higher than the maximum work pressure, such as to transfer gas to the accumulator, whenever the actual pressure in the accumulator would be lower than the current necessary, gas which, in case of excessive pressure compared to the actual need, should be released, obviously in the atmosphere, and consequently lost. Except than, as soon as the operating load should increase, to need to reintroduce gas in the accumulator.

In other words, the accumulator would be a one-way consumer of compressed gas, matter which would make the application impractical.

### 3. SUMMARY OF THE INVENTION

Therefore, the main aim of the present invention is to provide an apparatus and a method for automatic adjustment of the initial pressure inside an accumulator, preferably, but not necessarily, of the oleo-pneumatic type, in accordance to the current value of the operating load.

Such automatic adjustment, or tuning of the pressure inside the accumulator, allows the maximum recuperation of the energy that is made available during the operation of lowering of the operating load, also in the case in which the operating load would change consequently to the changed operating conditions of the operating machine which is taken in consideration.

By the way, every kind of operating machine for lifting and lowering of operating loads can take advantage from the present invention under the profile of energy efficiency.

### 4. SHORT DESCRIPTION OF THE DRAWINGS

For a better understanding of this invention, some preferred embodiments of the present invention are hereafter described, to be taken as not limitative examples, and with reference to the enclosed figures:

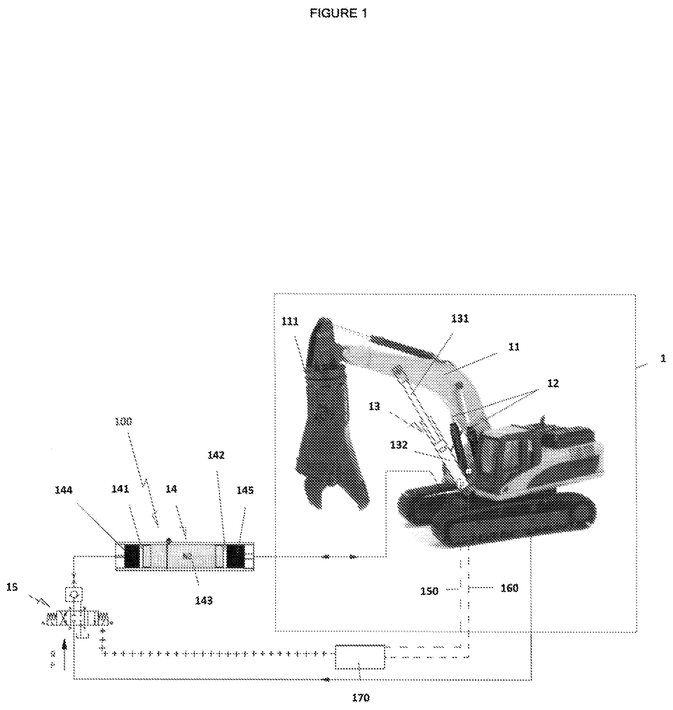

1. FIG. 1 shows a first embodiment of the apparatus which is the primary object of the present invention applied to an operating machine (an excavator, in the illustrated case); and

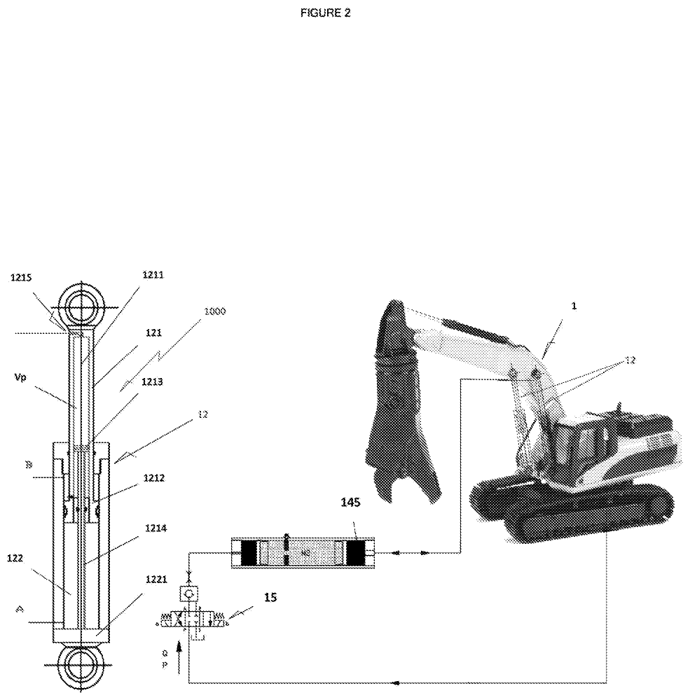

2. FIG. 2 shows a second embodiment of the apparatus primary object of this invention.

### 5. DETAILED DESCRIPTION OF THE INVENTION

For the purpose of description and explanation of the present invention, even if not necessarily and without any limitation to validity of this finding, it will be referred to the field of hydraulic excavators. Similarly, it might be made reference to different configurations, which can embody and implement this innovative method of self-adaptive recovery of hydraulic energy.

In FIG. 1 with 1 it has been indicated, in its complex, an excavator provided with a boom 11, a first end of which is pivotally connected to the mainframe of the excavator itself. Said boom 11 carries, at its other end, the so called lifted load, which can be a bucket, or, in the case shown in FIG. 1, an hydraulic shears, which can weigh up to 10 tons, and, according to the duty cycle, it might need to be replaced by a different equipment, with a quite different weight.

Boom 11 is controlled in its position by one or more hydraulic cylinders 12.

The whole of the weight of the used tool (bucket, hydraulic shears, etc.) added with the fraction of the weight of the boom (which does not rest directly on the excavator frame but on the actuation cylinders) form the so called “operating load” 111.

According to current practice, the lifting of operating load 111 takes place by supplying the oil, pressurized by a motorized pump, to the lower chamber of hydraulic cylinders 12.

Whereas, the lowering of operating load 111 takes place by controlled oil outflow through proper lowering valves, inside which the oil pressure is reduced from the value generated by operating load 111 down to the value of the oil tank, not shown in FIG. 1, which is substantially equivalent to the atmospheric pressure.

Such pressure reduction of the oil takes place by lamination of the same through the passage in very narrow orifices inside the lowering control valves, with the consequent total loss of the relative energy, substantially corresponding to the variation of potential energy of the operating load 111 in the lowering from the high position to the low position.

From the energetic view point, such energy is degraded into heat, which rises also a problem of heat management and dissipation.

In mathematical terms, said W the weight of operating load 111 and named H1 and H2 the height of the gravity center of operating load 111, respectively in high and low positions, the energy that has to be spent in the lifting is W×(H2−H1).

As we have said in the introduction part of this description, such energy is actually all lost during the lowering phase, for machinery not provided with energy recuperation systems, whereas it is very little recuperated, in the machinery provided with recuperation systems, according to the state of the art.

The maneuvers of lifting and lowering are generally very frequent in lifting machinery, and particularly in the type considered in this description, where such maneuvers, in the total duty cycle of the machinery, represent the prevalent reason of energetic consumption. Since the operations of lifting and lowering of an operating load take place within a conservative field of forces, the energy potentially recoverable during the lowering is, theoretically, equivalent to the one necessary for the further lifting, with the same operating load and the same height differences.

The present invention describes an apparatus and a method to approximate such a condition, through the accumulation and the recovery, rather than the loss, of a relevant rate of the energy made available during the lowering phase, and the return of the said energy during the next lifting maneuver.

In such a way, the energy that the machinery has to spend for every complete cycle is not any longer the total lifting energy, but the difference between this last and the recuperated one, by means of this invention, during the lowering.

For the only purpose of explanation of the theoretical principle of this invention, it will always be referred to FIG. 1, in which a first form of actuation of an hydraulic, self-adaptive, apparatus 100, is introduced.

In the embodiment shown in FIG. 1, the hydraulic apparatus 100 comprises an auxiliary hydraulic jack 13, an oleo-pneumatic accumulator 14, and a control valve 15 for the control of such oleo-pneumatic accumulator 14. As it will be better explained in the following, a particular embodiment includes the integration of the auxiliary hydraulic jack 13 inside the hydraulic actuators 12.

Also auxiliary hydraulic jack 13 is used to lift and lower boom 11, and, with it, operating load 111.

Such auxiliary hydraulic jack 13 is provided with a lower chamber 132 and an operative stem 131 (FIG. 1).

The accumulator 14 is provided, at one first end, with a first sliding piston 141, and, at the other end, with a second sliding piston 142.

The chamber 143, defined between the two pistons 141, 142, is filled with a given amount of inert pre-compressed gas, like Nitrogen, while the volumes of the accumulator outside the pistons 142 and 141, respectively 145 and 144, are connected, respectively, to the chamber 132 of the auxiliary hydraulic jack 13 and to the control valve 15, which can supply or discharge oil to, or respectively from, the chamber 144 of the accumulator 14, with the purpose to regulate the initial pressure Po of the gas in the chamber 143, according to a preset pressure target, which is related to the actual operating load 111, as it will be better explained below.

According to the invention, in the first embodiment shown in FIG. 1, the operating load can be split between the hydraulic actuators 12 and auxiliary hydraulic jack 13, in such a way that during the lowering operation of the operating load 111, the auxiliary hydraulic jack 13 pumps a volume Vh of oil into chamber 145, with consequent compression of the gas inside chamber 143, from the pressure Po, which is the pressure at the beginning of the lowering operation, up to pressure Ph, so as to store an amount of energy, equal to Vh×(Ph−Po). Ideally, to recuperate the maximum of the energy available with the lowering, W×(H2−H1), the auxiliary hydraulic jack 13 should take the total amount of the operating load 111, and Ph should result to be equal to the pressure that balances the operating load 111.

For given dimensions of the auxiliary hydraulic jack 13 and accumulator 14, if, for some reasons, the operating load 111 should change, like for instance in the case of replacement of the tool carried by the boom 11 shown in FIG. 1 with a lighter one, also Po should be reduced accordingly, with the scope to receive the volume Vh from the cylinder 13 anyhow at the maximum possible pressure.

In such a way it can avoided the drawback that Ph may result higher than the pressure of balance of the operating load 111, and then, in such a case, the lowering maneuver could not be completed.

Viceversa, in the case of replacement of the tool carried by boom 11 shown in FIG. 1 with a heavier one, also Po should consequently be increased, to maximize also the operative pressure Ph and, together with this, the recoverable energy Vh×(Ph−Po), and, consequently, to minimize the energy to be supplied by the hydraulic pump (not shown) during the next lifting maneuver.

To maximize the energy which can be accumulated in accumulator 14 during the lowering phase, one system could be, as previously seen, to adjust the amount of inert gas inside chamber 143 of accumulator 14, but this, as previously seen, would be expensive, bulky and hence absolutely not practicable.

On the contrary, according to the present invention, the amount of gas inside chamber 143 of accumulator 14 is kept constant, while the operative pressure Po is automatically tuned to operating load 111 by changing the initial volume Vo of the gas, by means of the regulation of the volume of oil within chamber 144.

Therefore the value of operative pressure in chamber 132 of auxiliary jack 13 is used as input signal to control the control valve 15, by means of a first control line 150 (FIG. 1).

At the very beginning of the lowering phase, a first pressure P1 (the one in the lower chambers of hydraulic cylinders 12, resulting from the actual value of the operating load), as well as a second pressure Po (the actual pressure of chambers 132 and 143 of hydraulic cylinder 13 with its rod in its outer position) are well known.

Both pressures are monitored, through appropriate sensors (not shown) by an electronic unit 170 (FIG. 1), for the control of control valve 15. Furthermore control valve 15, conveniently of the proportional type, is part of an hydraulic circuit comprising an hydraulic motorized pump (not shown), and such as to deliver or discharge small volumes of oil to, or respectively from, chamber 144.

As far as the pressure Po, for a given value of P1, is found at the beginning of the lowering of the boom to be lower than the one generating a calculated final pressure Ph, at the complete lowering of the operating load 111, such as P1 would be still very high, said electronic unit 170 activates control valve 15 in order to deliver oil to room 144, in adequate quantity to make sure that said final pressure Ph in chamber 144 results adequately high to make said pressure P1, at completed lowering of the boom 11, sufficiently low or next to zero.

Viceversa, if the pressure Po, always for a given value of P1, is higher than the value generating a calculated final pressure Ph, resulting at the completed lowering of the operative load 111, such as to make P1 equal to zero or negative, said electronic unit 170 activates control valve 15 in order to discharge oil from chamber 144, in adequate quantity to make sure that said final pressure Ph in chamber 144 results adequately reduced and does not bring to zero, at the end of the lowering of boom 11, the pressure P1.

Obviously, the readings of P1 and Po, at the very beginning of the lowering maneuver, determine, in line of principle, the adjustment of the oil charge in chamber 144 and, with it, the pressure Po.

At the next lifting, said oil pressure in chamber 143 acts on auxiliary jack 13, through chamber 132, and progressively decreases from the value Ph towards the value Po, as long as the said jack extends, and reaches a final value, anyway positive, which depends on the lifting travel of the same.

Maneuvers of lifting and lowering are positively controlled by cylinders 12, whereas jack 13 follows said maneuvers to accumulate a rate of energy, during the lowering, and to return it during the lifting. The higher is the said rate, the more effective is the recuperation of energy.

Obviously, whenever a lifting would be much longer than the immediately previous lowering, the jack would supply an amount of energy, higher than the one accumulated during the previous lowering, and viceversa. In such a way, the volume of chamber 144 is adjusted and Po, without intervening on the amount of inert gas in chamber 143.

Since an operating machine, in charge of lifting and lowering loads, like for example an excavator 1 as described, operates in dynamic conditions, it is not convenient to boost the accumulation of energy of lowering beyond a certain limit, since, differently, the accelerations of the operating load would result reduced, particularly in proximity of the reach of pressures of balance.

Therefore, the recuperation of the energy is not done integrally for reasons of dynamism and productivity of the machine, to leave more operative margins to controls.

As already said above, also for practical and manufacturing reasons, the auxiliary hydraulic jack 13 may conveniently, even if not necessarily, be integrated inside the hydraulic cylinders 12, as explained in the following.

To summarize, the inventive principle is to accumulate, during the operation of lowering the operating load 111, a volume of pressurized oil within an oleo-pneumatic accumulator 14, characterized by a fixed amount of inert gas, and the pre-charge pressure Po of which, before the beginning of the accumulation, is automatically adjusted according to the variations of the operating load 111, that is to the variations of the oil pressure inside the lifting cylinders 12, in such a way to accumulate the maximum hydraulic energy made available by the lowering of the operating load 111. This to maximize the average pressure of the hydraulic accumulator, during the accumulation phase.

The adjustment of pressure Po of pre-charge of the oleo-pneumatic accumulator 14 is obtained by changing the volume available for the gas in chamber 143, through the change of the volume of chamber 144 of oil, obtained by adding or subtracting oil from the chamber, by means of the use of control valve 15.

The pilot signal for the adjustment of the pressure Po could be, advantageously, also the operative pressure P1 inside hydraulic cylinders 12, said operative pressure read by means of a second control line 160 (FIG. 1) during the last lifting maneuver.

The automatic adjustment of the initial pressure takes place according to the criterion to allow the complete lowering of operating load 111, without slowing down the lowering speed under a value operatively optimum.

As it has been previously said, conveniently but not necessarily, at least one portion of an hydraulic equipment 1000 according to a second form of implementation of this invention (FIG. 2) can be integrated inside the hydraulic cylinders 12.

Particularly, auxiliary jack 13 can be integrated inside the hydraulic cylinders 12, according to what has been shown in the second embodiment of FIG. 2.

Therefore, with reference now to FIG. 2, the rod 121 of the hydraulic cylinder 12 is hollow, as well as hollow is piston 1212, that is presenting a longitudinal hole, to embody a cylindrical chamber 1211, open underneath towards the chamber 122, and connected above, by means of a duct 1215, to the chamber 145 of the accumulator 14.

Inside cylindrical chamber 1211, is placed a piston 1213, the axial position of which is fixed, both in the extension and in the return of rod 121, by means of a rod 1214, permanently connected to the bottom 1221 of the chamber 122 of the hydraulic cylinder 12. Between the piston 1213 and the top of the cylindrical chamber 1211 a volume Vp of oil is included.

During the phase of lowering of the operating load 111, the rod 121 and the piston 1212 go inside the chamber 122.

Consequently, the volume Vp decreases and the oil therein contained is pumped to the chamber 145 of the accumulator 14, thus compressing the gas of the room 143, from the initial pressure Po up to the pressure Ph, and, therefore, accumulating an energy substantially equal to the result of the mathematic multiplication of the pumped volume by the pumping pressure increase.

During the lifting phase, rod 121 extends outside cylinder 12, under the effect of the pressure P1 of control of the lift, generated by the hydraulic system (not shown), consequently the volume Vp increases under also the effect of the pressure of the oil returned from chamber 145 of the accumulator, due to the pressure of the inert gas there contained and pressurized. The increase of the volume Vp under the effect of the pressure inside chamber 1211 returns the accumulated energy to the system.

Many other embodiments of accumulators are possible, for instance of the type with diaphragm or membrane, or simplified versions of the one shown in FIG. 1, where chamber 145 receives both oil from chamber 132 and from control valve 15, which anyway share, together with the described example, the principle to change the initial pressure of the inert gas inside, through a volume of oil introduced in relation to the working pressure of the lifting cylinders, as detected in the last lifting operation, and without changing the amount of compressible gas.

The main advantage of the present invention consists in the fact that the ratio between the energy accumulated during the lowering of a given operating load and the total energy necessary to lift the said operating load is made on the basis of optimization of the energy saving, without compromising the functionality and the productivity of the machinery.

The solution object of the invention updates automatically such optimization as the operating load 111 changes.

It is considered optimal, for both energy recuperation and quick response of the machinery, that the ratio between accumulated energy and total energy spent for the lifting operation goes around a value included between 0.65 and 0.75.

1. Hydraulic apparatus (100) for energy recovery in an operating machine (1);
hydraulic apparatus (100) characterized in that it comprises:
accumulation means (14) able to accumulate, during the operation of lowering an operating load (111) by said operating machine (1), a volume of oil with a fixed quantity of an inert compressible fluid, and whose pressure (Po) of pre-charging, before the start of the accumulation, is adequate for the variations of oil pressure inside actuation means (12, 13) of said operating load (111), so as to accumulate the maximum hydraulic energy made available by the lowering of this operating load (111), or by maximizing the average pressure of said accumulation means (14) during the energy accumulation phase.

2. Apparatus (100), as claimed in claim 1, characterized in that said accumulation means (14) are of the oleo-pneumatic type.

3. Apparatus (100), as claimed in claim 1, characterized in that of being of the self-adaptive type.

4. Apparatus (100), as claimed in claim 1, characterized in that said accumulation means (14) comprise, at a first end, a first sliding piston (141), and, at the other end, a second sliding piston (142).

5. Apparatus (100), as claimed in claim 4, characterized in that a chamber (143) defined between said two sliding pistons (141, 142) is filled with a given quantity of pre-compressed inert gas, while the volumes (145, 144) of said accumulation means (14) external to the sliding pistons (141, 142) are connected, respectively, to a chamber (132) of an auxiliary jack (13) and to a valve (15); said valve (15) being adapted to discharge oil to or from the chamber (144) of said accumulation means (14), in order to regulate the initial pressure (Po) of the chamber gas (143), according to a given pressure target, which is related to the current operating load (111).

6. Apparatus (100), as claimed in claim 5, characterized in that the auxiliary jack (13) is integrated in actuating means (12, 13) of an operating machine (1).

7. Operating machine (1) characterized in that it is provided with at least one apparatus (100) of the type claimed in claim 1.

8. Method for energy recovery in an operating machine; method characterized by accumulating, during the operation of lowering an operating load (111), a volume of oil under pressure inside accumulation means (14) with a fixed quantity of an inert fluid, and whose pressure (Po) of pre-charging, before the start of the accumulation, is adequate to the variations of oil pressure inside actuating means (12, 13) of the operating load (111), so as to accumulate the maximum hydraulic energy made available by the lowering of the operating load (111) itself, or by maximizing the average pressure in said accumulation means (14) during the accumulation phase.

9. Method, as claimed in claim 8, characterized by monitoring all the pressures through appropriate sensors controlled by an electronic control unit (170) for controlling a control valve (15) adapted to control said accumulation means (14).

10. Method, as claimed in claim 9, characterized in that if a pressure (Po) inside hydraulic control means (13), for a given pressure value (P1) of hydraulic actuator means (12), it is found at the beginning of the lowering of the arm lower than that generating a final calculated pressure (Ph) resulting in a complete lowering of the operating load (111) such as to make the pressure (P1) still considerably high, an electronic control unit (170) activates a solenoid valve (15) in such a way as to send oil to a chamber (144) of said accumulation means (14) in an amount sufficient to cause said final pressure (Ph) in said chamber (144) to be sufficiently high to make the said pressure (P1) at the end of the arm (11) sufficiently small or close to zero; vice versa, if said pressure (Po), again for a given pressure (P1), is greater than the value generating a final calculation pressure (Ph) resulting in a complete lowering of the operating load (111) such as to render said pressure (P1) too low or close to zero, said electronic control unit (170) activates said solenoid valve (15) so as to discharge oil from said chamber (144) in an amount sufficient to cause said final pressure (Ph) in said chamber (144) it is consequently reduced and does not cancel, at the end of the lowering of the arm (11), said pressure (P1); the reading of said pressures (P1, Po), at the beginning of the lowering maneuver, determine the adjustment of the quantity of oil in said chamber (144), and, with it, said pressure (Po).
